(19) United States
(12) Patent Application Publication
(10) Pub. No.: US 2024/0036588 A1
(43) Pub. Date: Feb. 1, 2024

(54) Interface, method and system for supervising the supply of consumables to stations of a production line

(71) Applicant: SIDEL PARTICIPATIONS, Octeville-sur-Mer (FR)

(72) Inventors: Vincent BRACHET, OCTEVILLE-SUR-MER (FR); Nicolas CHOMEL, OCTEVILLE-SUR-MER (FR); Jean-Claude WAELDIN, OCTEVILLE-SUR-MER (FR)

(21) Appl. No.: 18/360,343

(22) Filed: Jul. 27, 2023

(30) Foreign Application Priority Data
Jul. 28, 2022 (FR) 2207796

(51) Int. Cl. G05D 1/02; B65G 1/137

(52) U.S. Cl. CPC G05D 1/0291; B65G 1/137; G05D 2201/0216

(57) ABSTRACT

Provided is an interface for supplying consumables to a product processing station, with an entry accessible to an autonomous mobile robot (AMR) transporting a consumable corresponding to the processing station and means for automatic transfer of the consumable from the AMR to a reception space. The reception space can be integrated with the processing station, where the transfer means has an automatic loading means dedicated to the consumable to be transferred and to each reception space of particular processing stations to be supplied with the corresponding consumable. Also provided is a production line in which at least one of the stations is equipped with the interface, as well a method for managing the supply of consumables to this production line. Also provided is a system for supervising the supply of consumables to particular stations.

### TECHNICAL FIELD OF THE INVENTION

The present invention relates to the field of industrial lines for the production and manufacture of products.

In the sense of the present invention, the term “product” covers an individual object. Such a product is a receptacle, for instance a bottle or a flask, or a cardboard container, or a can. A product may be made of any type of material, in particular plastic material, metal or glass. Depending on its shape and its material, a product may be rigid or semirigid.

Such a receptacle is intended to contain, without limitation, a fluid, a liquid, powders or granules, in particular of the food industry or cosmetics type.

Furthermore, a product may have any type of shape, symmetrical or asymmetrical, regular or irregular. In addition, a product may have a rounded cross section, of circular or ovoid shape overall, or a polygonal cross section, in particular rectangular or square.

In particular, such a receptacle comprises a bottom which may be flat or substantially flat, or conversely having one or more cavities, as is the case for example with a can having a concave bottom or a bottle having a so-called “petaloid” bottom.

As is known, the products may be subjected to a plurality of successive different processing operations along an industrial line, for instance the manufacture of the container, for example during an operation of plastics injection-molding or stretch-blow-molding from a preform in the case of a plastic bottle, followed by filling then sealing with a stopper and labeling. At the end of these processing operations, the products are referred to as “finished”.

With a view to their handling, such finished products subsequently undergo batch packaging.

Furthermore, each batch comprises a group of a plurality of products combined in a matrix arrangement, generally having a parallelepipedal overall shape, often square or rectangular, in columns and rows. For example, a conventional batch combines six products in two rows and three columns.

Once the groups of products have been produced, each group may be packaged by wrapping or boxing.

Wrapping consists in enclosing or covering the group of products with a sheet or a film, so as to hold the products together and to facilitate the handling of such a batch obtained in this way. Such wrapping may be carried out through a filming or preferably shrink-wrapping step, or by wrapping by means of a sheet, in particular of paper or cardboard.

Finally, the batches are stacked or superposed with a view to their transport and their storage, during a palletizing operation.

Each operation is carried out by a station dedicated to the corresponding processing, along said production line.

This being the case, with a view to carrying out their processing, certain stations need to be supplied with corresponding consumables, for example with pellets of plastic material in the case of the station for molding the preforms, with preforms in the case of the station for blow-molding or stretch-blow-molding of a plastic receptacle, with stoppers in the case of the sealing station, with rolls of labels in the case of the labeling station, with rolls of plasticized film in the case of the shrink-wrapping station, with pallets and inserts in the case of the palletizing station, or with cardboard cutouts in the case of the forming and boxing station, etc.

The invention preferably concerns the consumables associated with the primary packaging, namely those associated with the manufacture of the finished products, for instance the preforms, the labels, the stoppers, etc.

Such consumables are usually brought from a storage zone to the vicinity of the corresponding station, where the consumables are transferred in order to supply said station.

### PRIOR ART

Currently, the transport of consumables from the storage zone to the corresponding station along the production line is carried out using a truck, in particular a forklift truck.

Generally, such a truck is driven by an operator, although it has been automated for a number of years in related technical fields. Such automatic trucks may be of two types:
AGV (“Automated Guided Vehicle”), an autonomous truck which moves along a predefined path; and
AMR (“Autonomous Mobile Robot”), a robot which moves freely under the control of logistics management software.

Recently, AGVs have tended to be replaced by AMRs on most manufacturing lines because of their operating flexibility and their versatility, as well as the ease with which they can be implemented without modifying the infrastructure or adding transmission/reception and/or path control devices, which are usually required for AGVs.

Thus, such autonomous robots make it possible to go and find the consumables then bring them to the vicinity of said station.

In this regard, once in position, the consumables, which are generally stored on a pallet, are deposited in the vicinity of the corresponding station then the robot departs. The consumables then need to be transferred to said station, an operation which is carried out manually by an operator.

Correlatively, once the pallet has been emptied, it should be removed.

Besides the tedious nature of the transfer, as well as the various consumables which may accumulate in the vicinity of a plurality of consecutive stations, for example as is the case for a bottling module which receives labels and stoppers, access to the machines of said station may be dangerous during operation. It is for this reason that the stations are not directly accessible, but are surrounded by locked enclosures in order to protect the operators.

Thus, during the supplying of a machine, it is necessary to unlock the enclosure in order to enter it with a view to supplying the corresponding machine. Such unlocking entails a slowdown, or preferably a shutdown, of the corresponding machine until the operator recloses the enclosure once the consumable has been supplied.

The loss of time and the reduction in production efficiency each time consumables are replaced on a station will readily be understood.

What is more, the operator is often required to open the boxes which have been brought and deposited at their feet with a view to accessing the consumables in order to supply the machine. This also results in a consequent loss of time, as well as a concern to supply the various consumables deposited around a given module in order. Furthermore, it is difficult for an operator to carry out several loading operations manually within a given time limit, in particular because of the physically exhausting handling operations, while complying with certain hygiene and cleanliness prerequisites of certain consumables to be loaded. This may result in an abrupt break in production, which is undesirable with a view to maintaining optimum efficiency.

In this regard, the high throughputs of a receptacle production line, of the order of 60,000 to 120,000 products per hour, require a regular supply of consumables, especially in small and unitary format, for example as is the case with stoppers. It is not uncommon for supplying of a station along a production line to take place every five minutes, requiring as many operators or their movement along the production line in order to carry out each supply. The high frequency of the loading operations demands rigorous organization of the supply and loading of the consumables, placing not inconsiderable pressure on the operators of the teams responsible for performing these tasks. Furthermore, the operators need to be trained for the various machines of each station in order to supply them under optimal conditions, leading to organizational constraints in terms of costs and safety.

Lastly, resorting to human intervention usually leads to errors and mishandling, correspondingly affecting the production efficiency. Furthermore, manual handling is precarious and based on experience, and is very tiring and physically demanding for the operators. Even though the handling may be assisted, in particular by a robotized manipulator equipped with a tool for gripping the consumable, the unloading of the consumables with a view to supplying each of said stations remains subject to human intervention and the constraints relating thereto.

Moreover, the management of the transfer of the consumables from the storage zone to the production line, in particular of each consumable to each of the corresponding stations, is nowadays supervised by a management system. Such a system receives information from sensors which are present at each of said stations, particularly in a space for reception of the consumable, for instance a magazine or reservoir, said sensor indicating the level of use of a consumable by the corresponding station. In brief, below a threshold it is necessary to provide for supplying of said station with a consumable. The consumable must therefore already be present in the vicinity of the station to be supplied when the crossing of the threshold occurs, so that the operator can prepare then carry out the supply in a period of time before said consumable runs out, which would lead to a shutdown of said station.

From what has been stated above, the problems resulting from this precarious management will readily be understood. Furthermore, the transfer of the consumables from the storage zone requires taking into consideration a duration for making the journey, both outward and return.

In this regard, a separate manager currently deals with managing the movements of the robots (AMRs) within the production site, in particular between the storage zone of the consumables and the stations of the production line. This manager makes it possible to organize the outward and return journeys of the robots as a function of the needs of the stations for consumables during production. Such a manager is often integrated or communicates with a software suite for management of the production line.

Although such a manager makes it possible to manage the movements of the robots, it remains limited to this interaction, not allowing optimized planning of the supply of corresponding consumables to the stations in question.

### SUMMARY OF INVENTION

The object of the invention is to overcome the drawbacks of the prior art by proposing to supervise and automate the corresponding supply of consumables to the stations in question of a production line, through an interaction between interfaces for supplying consumables to certain stations in question of the production line, a method for managing the supply and a system for supervising the transfers of said consumables.

Thus, the invention first relates to an interface, e.g., a consumables supply interface where an interface is a boundary shared by two systems or machines enabling exchanges between them, for supplying consumables to a product processing station, comprising:
an entry accessible to an autonomous mobile robot (AMR) transporting a consumable corresponding to said processing by said station in question;
means for automatic transfer of said consumable from said robot (AMR) to a reception space for said consumable, said reception space being integrated with said processing station.

Such a supply interface is one wherein transfer means comprise automatic loading means dedicated
i) to said consumable to be transferred,
and
ii) to each reception space of the certain processing stations to be supplied with said corresponding consumable.

According to additional nonlimiting features, such an interface may comprise an unloading zone provided with said transfer means.

According to one embodiment, said interface comprises an enclosure integrating said entry communicating with said unloading zone, which is then located inside the enclosure, said entry being accessible by said robot (AMR) upon verification.

According to one embodiment, said interface comprises means for controlling the access to the entry of said enclosure, said control means comprising means for recognition of and communication with said robot (AMR).

According to one embodiment, said loading means comprise
i) means for taking hold of a media for transport of the consumable,
ii) means for extraction of the consumable from said transport media.

The invention also relates to a line for the production of products of the receptacle type, which is provided with at least one station equipped with an interface for supplying consumables to a processing station according to the invention.

Such a production line comprises:
successively along said line, a plurality of stations for processing said products, certain of said processing stations using consumables, each of said consumables corresponding to the processing of said products by one of said certain processing stations in question;
a zone for storage of said consumables;
mobile means for transport of said consumables from said storage zone to said certain processing stations.

Said production line is one wherein
each of said certain processing stations is equipped with a supply interface according to the invention.

The invention also relates to a method for managing the supply of consumables to certain processing stations of a production line according to the invention.

Such a management method comprises at least the following steps, without limitation:
the transport of a consumable from a storage zone to one of the certain processing stations is instructed;
a mobile autonomous robot (AMR) transports said consumable from the storage zone to said one of the certain processing stations;
said consumable is transferred and loaded from said mobile robot (AMR) to said reception space of said one of the certain processing stations.
   Said management method is one wherein, during the transfer,
said robot (AMR) positions itself with respect to a supply interface with which said one among the certain processing stations is equipped,
said consumable is automatically transferred from said robot (AMR) to said reception space via the loading means of said interface,
said robot departs.

According to additional nonlimiting features, during the transfer,
said robot (AMR) positions itself by entering inside an unloading zone which is accessible via a secured entry,
the access of said robot (AMR) through said entry is controlled.

According to one embodiment, the access of said robot (AMR) through said entry is controlled by recognition and communication from said interface.

According to one embodiment, the same robot (AMR) departs with at least one transport media emptied of the consumable.

According to one embodiment, the transport of said consumable is instructed automatically via a signal transmitted by a sensor of the level of consumption of the consumable used inside said reception space of the processing station in question.

The invention also relates to a system for supervising the supply of consumables to processing stations of a production line according to the invention, that is to say at least a certain one of the stations is equipped with an interface according to the invention, involving the management method according to the invention.

Such a supervision system is a computer program, that is to say it is run through at least one informatics terminal.

According to the invention, such a supervision system comprises:
at least one software module for assigning tasks to at least one robot (AMR), said tasks comprising at least the transport of consumables from said storage zone to said certain processing stations, one of said consumables in particular corresponding to one of said certain processing stations in question,
at least one module for receiving a signal instructing the supply of said corresponding consumable, said signal being transmitted by said processing station in question.

Said supervision system is one wherein said assignation module communicates with said module on reception of said signal in order to initiate one of said tasks consisting at least in the management method according to the invention.

According to additional nonlimiting features, said reception module makes it possible to receive an end of supply notification at the end of said one of said tasks.

According to one embodiment, said supervision system comprises a module for communication with a separate manager of the movements of said at least one robot (AMR), said communication module and said assignation module cooperating for planning of said tasks.

According to one embodiment, said tasks comprise the transport by said at least one robot (AMR) of at least one transport media, emptied of its consumable, from one of the certain processing stations.

Thus, through an interoperability between the subjects mentioned above, the invention makes it possible to supply each station in question with the corresponding consumable, directly and automatically, at the most optimized moment, while maintaining maximum efficiency of the production line. What is more, the interface allows secured loading directly from the robot which transports the consumable, in order to automatically supply the magazine of the station in question.

Furthermore, the robot may depart directly with one or more supports on which the consumable was delivered, improving the safety of the vicinity of the production line.

### DESCRIPTION OF THE DRAWINGS

Other features and advantages of the invention will become apparent from the following detailed description of nonlimiting embodiments of the invention, with reference to the appended figures in which:

FIG. 1 schematically represents a simplified view of the architecture of a line for the production of products of the plastic bottle type, showing in particular the various stations to be supplied with the corresponding consumables from a storage zone;

FIG. 2 schematically represents a view of a detail of an architecture of a production line according to the invention, showing in particular each consumable supply interface of two separate stations of the production line, as well as the routing of an autonomous robot for transporting said corresponding consumables from the storage zone to each of said interfaces of said two stations;

FIG. 3 schematically represents a view of a detail of an embodiment of said architecture, showing in particular the transport by a robot (AMR) on instruction of a consumable to a station of the production line equipped with a reception space and, after verification of the access to said station, the transfer of said consumable by the interface from said robot (AMR) located in an unloading zone to said reception space.

### DETAILED DESCRIPTION

The present invention relates to the field of industrial lines 1 for the production and manufacture of products.

The invention specifically concerns a line 1 for the production of products, referred to below as a “production line 1”.

As mentioned above, said products are of the receptacle type, intended to contain, without limitation, a fluid, a liquid, powders or granules, in particular of the food industry or cosmetics type.

The production line 1 performs a plurality of successive different processing operations, for instance the manufacture of the container, for example during an operation of plastics injection-molding or stretch-blow-molding from a preform in the case of a plastic bottle, followed by filling then sealing with a stopper and labeling. At the end of these processing operations, the products are referred to as “finished”. These operations are carried out along an upstream part of said production line 1.

Subsequently, the production line 1 comprises a downstream part, along which the finished products are grouped and packaged with a view to their handling, through a so-called “packing” operation, then palletized with a view to their transport and storage.

FIG. 1 shows various steps of the processing operations which take place successively along an exemplary line for producing bottles of the plastic bottle type containing a beverage, from the manufacture of the preforms 101 to the palletizing.

For this purpose, the production line 1 successively comprises along said production line 1 a plurality of stations 2 for processing said products, referred to below as a “station 2” or “processing station 2”. Furthermore, certain of said processing stations 2 use consumables, each of said consumables corresponding to the processing of said products by one of said certain stations 2 in question.

As mentioned above, for the upstream part of the line, the consumables comprise pellets 100 of plastic materials in the case of the station for molding the preforms, preforms 101 in the case of the station for blow-molding or stretch-blow-molding of a plastic receptacle, stoppers 102 in the case of the sealing station, rolls 103 of labels in the case of the labeling station. The invention preferably concerns such consumables associated with the primary packaging.

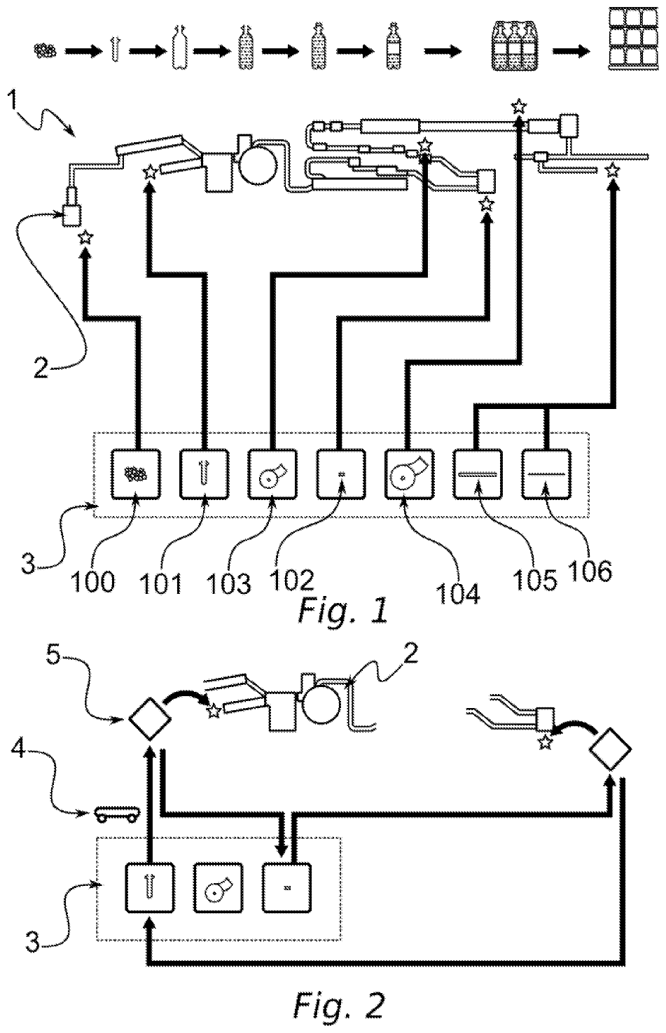

FIG. 2 shows an example of three primary consumables, namely a preform 101, a roll of labels 102 and a stopper 103, which are intended to supply a plurality of stations 2 spaced apart along the production line 1.

Correlatively, the invention may include the consumables used by the stations 2 of the downstream part, for instance rolls 104 of plasticized film in the case of the shrink-wrapping station, pallets 105 and inserts 106 in the case of the palletizing station, or cardboard cutouts for the forming and boxing station.

Furthermore, each station 2 which uses a consumable comprises a reception space 20. Such a reception space 20 is dedicated to the consumable used by the station 2 in question. It may be a reservoir or a magazine, inside which the corresponding consumable is introduced in order to be used by the machines of said station 2 in the course of the processing of the products.

For example, in the case of a consumable such as preforms 101 or stoppers 102, the reception space 20 respectively of the blow-molder or of the sealing station may be a hopper, into which said preforms 101 or said stoppers 102 are poured. In the case of a labeler, the reception space 20 may be a reel equipped with one or more spindles for receiving the rolls 103 of labels.

This being the case, the production line 1 comprises a zone 3 for storage of said consumables. Such a storage zone 3 is located on the production site in proximity to one or more production lines 1. The consumables, as well as replacement parts and the maintenance products for the machines are stored and inventoried therein, with a view to supplying the stations 2 in question of each of the production lines 1.

For this purpose, said production line 1 also comprises mobile means for transporting said consumables from said storage zone to said certain stations 2.

In the context of the invention, such mobile transport means are entirely automated, there being two types, namely:
AGV (“Automated Guided Vehicle”); and
AMR (“Autonomous Mobile Robot”), referred to below as a “robot 4”.

Preferably, the mobile transport means are robots 4 of the AMR type.

Furthermore, the production line 1 may integrate a separate manager 6 intended for supervision of the movements of each of the robots 4 within the production site comprising said one or more production lines 1.

FIG. 1 shows particularly in solid arrows the movements of the robots 4 in order to supply consumables from the storage zone 3 to each of said stations 2 in question of the production line 1.

Furthermore, the robots 4 of the AMR type may manage their paths autonomously and independently after a period of learning the environment of the production site, avoiding obstacles and personnel encountered during their movements, offering enhanced safety in comparison with transport controlled by an operator, for example a driver of a forklift truck.

Advantageously, within the production line 1, each of said certain stations 2 is equipped with a consumable supply interface 5. In addition, each interface 5 is dedicated on the one hand to said consumable to be transferred, and on the other hand to each reception space 20 of the certain stations 2 to be supplied with said corresponding consumable.

Furthermore, the invention concerns the supply of consumables to certain of the stations 2 of said production line 1, namely the stations 2 in question which use the corresponding consumables during the processing applied to the products.

What is more, the invention envisions automation of this supply. Such automation of the supply, and especially of the loading of the consumables dedicated to the corresponding stations, is crucial for optimizing the production and limiting the risks of accidents for the operators, as well as of interruption to said production.

For this purpose, the invention relates to an interface 5 for supplying consumables to a station 2 for processing products. As mentioned above, each of said certain stations 2 requiring a supply of corresponding consumables is equipped with said interface 5.

Consequently, the interface 5 is adjacent to, located beside or in proximity to the station 2, in particular at the edge of the production line 1, or integrated with the station 2.

Such an interface 5 comprises an entry 50 accessible to an autonomous mobile robot 4, namely one of said robots 4 transporting a consumable corresponding to said processing by said station 2 in question.

Said entry 50 may be a simple passage, optionally delimited, for access to said station 2, or a mobile wall, for instance a gate, arranged in an enclosure surrounding the interface 5 and/or said station 2.

Furthermore, said interface 5 comprises means for automatic transfer of said consumable from said robot 4 to the space 20 for receiving said consumable, that is to say said reception space 20 is integrated with said station 2 in question. In brief, the transfer means make it possible to take the consumable transported by the robot 4 and move it to the magazine or the reservoir of the station 2 in question.

For this purpose, the transfer means advantageously comprise automated loading means dedicated on the one hand to said consumable to be transferred, and on the other hand to each reception space 20 of the certain stations 2 to be supplied with said corresponding consumable.

Such loading means may therefore be of any type, configured and suitable in respect of the consumable to be extracted from the robot 4 which has just transported it to the station 2, as well as in respect of the reception space 20 inside which the consumable is to be placed.

For example, the loading means may be means for gripping each consumable one by one or a plurality of consumables simultaneously, means for conveying one or more consumables, means for movement by pushing or pulling horizontally or substantially horizontally, means for filling with a plurality of consumables, in particular by pouring into a hopper.

Furthermore, the loading of the consumable may be carried out directly by taking hold of one or more consumables, or indirectly by acting on a media 7 for transport of said consumable.

Such a transport media 7 may be of any type dedicated to the consumable to be transported. For example, it may be a pallet 105 on which one or more consumables are deposited, as is the case for the rolls 103 of labels. Furthermore, the transport media 7 may be equipped with tooling suitable for handling the consumable, in an automated fashion or assisted by an operator. As regards small consumables, for instance preforms 101 or stoppers 102, they may be one or more cases or boxes, or bags or sachets. The transport media 7 may also rest on a pallet 105 handled by said robot 4.

Advantageously, given that the transfer is carried out automatically, the loading means are automated. Preferably, the loading means comprise robotized means, for instance a multi-axial robotized arm, mounted on the structure of the interface 5, of the station 2, or through a suitable gantry.

According to the embodiment mentioned above, with media 7 for transporting the consumable or consumables, the loading means are suitable for taking said media 7 and all the consumables placed thereon in order to transfer them to said reception space 20 of the station 2.

Consequently, said loading means comprises means for taking hold of the media 7 for transport of the consumable, as well as means for extracting the consumable from said transport media 7.

As mentioned above, the extraction may be of any type during the loading of the reception space 20, and the extraction means are configured in a complementary way in order to handle said media 7.

For example, in the case of a media 7 in the form of a box, for a consumable such as preforms 101 or stoppers 102, the loading means may then comprise means for taking hold of one or more boxes by grasping or gripping, lifting it from the robot 4 and moving it to the reception space 20 of the station 2, as well as means for extraction by inverting said box or boxes in order to pour said preforms 101 or said stoppers 102 into a hopper with which the station 2 or the interface 5 is equipped.

According to one embodiment, the interface 5 comprises an unloading zone 51 provided with said transfer means. Said unloading zone 51 is dimensioned to make it possible to internally receive said robot 4, at least partially but preferably fully.

In addition, such an unloading zone 51 may be delimited visually by marking on the floor or physically by walls, or by nonphysical barriers delimited virtually by transmitters/receivers or any other suitable means.

In this regard, according to one embodiment, the interface 5 comprises an enclosure 52 integrating said entry 50 communicating with said unloading zone 51, which is then located inside the enclosure 52.

Furthermore, said entry is accessible by said robot 4 upon verification, that is to say the access is not free and is subjected to access restrictions, in particular locking of the entry 50, for example by locked and remotely controlled closing of the gate of said entry 50. According to a complementary embodiment, the enclosure 52 is combined with or forms part of the safety enclosure surrounding said station 2, in particular when the interface 5 is integrated with said station 2.

According to one embodiment, the interface 5 comprises means for controlling the access to the entry 50 of said enclosure, said control means comprising means for recognition of and communication with said robot 4. In brief, it is the interface 5 which integrates a means suitable for discerning the robot 4 on its approach to the entry 50, in particular by using means of communication between the interface 5 and said robot 4, or via the manager 6 of the movements of said at least one robot 4. In brief, depending on the station 2 to be supplied, the interface 5 may communicate remotely in order to dialog with said robot 4, the manager 6, or alternatively a supervision system 8 (as described below).

Thus, the unloading means may intervene in order to transfer the consumable from the robot 4 in a secured zone, without risk for an operator.

In the case in point, at least one of the stations 2 in question of the production line 1 comprises an interface 5 according to the invention, which performs the automated transfer and loading of the corresponding consumable.

Preferably, each of the certain ones of said stations 2 of the production line 1 comprises an interface 5.

The invention also relates to a method for managing the supply of consumables to certain processing stations 2 of a production line 1 according to the invention. Such a management method comprises a plurality of steps, without limitation.

First, the transport of a consumable from a storage zone 3 to one of the certain stations 2 is instructed. In particular, the corresponding consumable is dedicated to said station 2 in question.

Furthermore, an autonomous mobile robot 4 transports said consumable from the storage zone 3 to said one of the certain stations 2.

Once it has arrived in position, said consumable is transferred and loaded from said robot 4 to said reception space 20 of said one of the certain stations 2. The transfer and the loading are carried out by dedicated loading means, optionally by taking hold of the transport media 7.

Advantageously, during the transfer, said robot 4 is positioned with respect to a supply interface 5 with which said one among the certain processing stations 2 is equipped.

According to one embodiment, said robot 4 is positioned by entering inside an unloading zone 51 which is accessible via a secured entry 50 and the access of said robot 4 through said entry 50 is controlled, whether it is a passage or a gate.

Furthermore, according to the corresponding embodiment, the access of said robot 4 through said entry 50 is controlled by recognition and communication from said interface 5, that is to say it is the interface 5 which identifies the robot 4 and authorizes it to enter the unloading zone 51, in particular by direct communication with said robot 4 or by communication with the manager 6 of the movements of said robot 4.

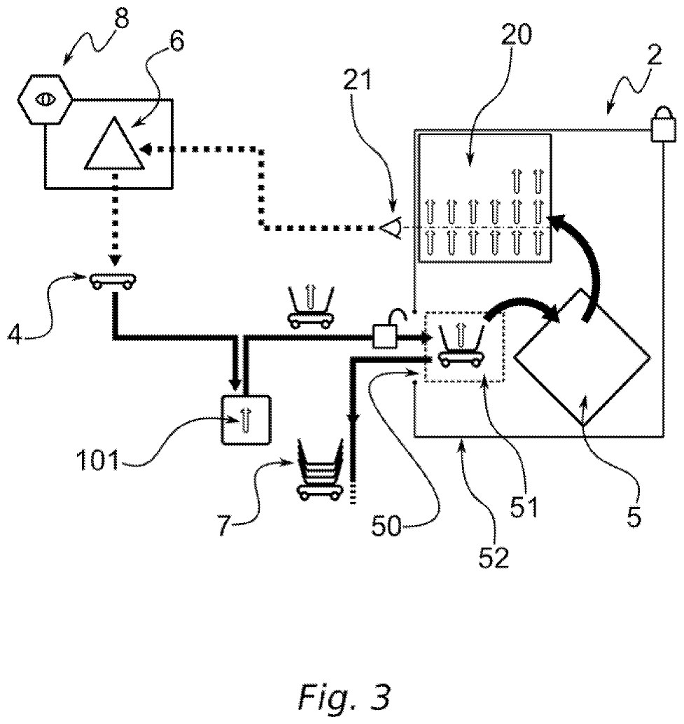

FIG. 3 shows in particular the secured access with control of the access to the entry in the form of an open padlock, while the enclosure remains closed (i.e. with a closed padlock).

Subsequently, said consumable is transferred automatically from said robot 4 to said reception space 20 via the loading means of said interface 5.

Once the loading has been performed, said robot 4 departs.

Usually, said robot 4 may depart empty, optionally with a pallet 105 which was used as a support for said consumable or for one or more media 7 for transporting said consumable. FIG. 2 shows an example of a robot 4 which departs empty after having delivered preforms 101 to a blow-molding station 2, before going to find stoppers 103 in order to transport them to the bottling station, in particular to the sealing machine, located upstream of the production line 1.

According to one embodiment, said same robot 4 departs with at least one empty consumable transport media 7. This media 7 may be the one transported by the robot 4 or a media previously taken hold of for loading a previous consumable. Furthermore, the robot 4 may recover a plurality of media 7, for example stacked, before departing with them to a location dedicated to storing empty media 7, as may be the case inside the storage zone 3. FIG. 3 shows in particular a robot 4 departing with a plurality of superposed medias 7, of the box or tub type.

Correlatively, the robot 4 may depart loaded with other components, for instance waste or worn parts, or equipment necessary for maintenance of a station to which it has gone in order to supply it with a consumable. In particular, the robot 4 may take hold of one or more waste containers in order to transport them to a selective sorting zone or to disposal.

According to one embodiment, the transport of said consumable is instructed automatically via a signal transmitted by a sensor 21 of the level of consumption of the consumable used within said reception space 20 of the station 2 in question. In brief, the degree of use of the consumable from its magazine or reservoir is checked continuously or at regular intervals, then once a low threshold has been reached and detected a signal is sent to instruct the consumable supply by a robot 4 which is located in the storage zone 3 or goes there in order to recover it and transport it to the station 2 in question.

FIG. 3 shows particularly in dashed arrows the signal which is emitted by the sensor 21 when the level of preforms 101 passes below a certain detection threshold, with the sending of an instruction to a robot 4.

It will be noted that the consumption threshold is defined in particular as a function of the period of time, or an average period of time, necessary for a robot 4 to perform the movement in order to recover the consumable from the storage zone 3 then bring it to the station 2, as well as the time necessary for its transfer and its loading, taking into account a rate of use of the consumable by said station 2 during operation.

Thus, given that the transfer and the loading of the consumable are automated, the ordering of said consumable is as well, without the need for intervention by an operator in order to monitor the level of use of the consumable or to send an instruction for receiving said consumable.

Thus, the management method according to the invention performs a task of supplying a consumable to a station 2.

Furthermore, as mentioned above, the management of the movements of the robot 4 may be carried out by means of a separate manager 6, or one which is combined with an overall system.

For this purpose, the invention also relates to a software system 8 for supervising the supply of consumables to processing stations 2 of a production line 1.

Such a system 8 is software in the form of one or more computer programs, said system 8 being run through at least one informatics terminal, for instance an informatics server or a computer.

Advantageously, said supervision system 8 comprises at least one software module for assigning tasks to at least one robot 4. Furthermore, said tasks comprise at least the transport of consumables from said storage zone 3 to said certain stations 2, one of said consumables in particular corresponding to said certain stations 2 in question (for example the transport of preforms 101 in the case of the blow-molding station 2).

The supervision system 8 also comprises at least one module for reception of a signal instructing the supply of said corresponding consumable, said signal being transmitted by said station 2 in question. In particular, it may be a signal transmitted by the sensor 21 upon detection of an insufficient stock of consumable in the reception space 20 of the station 2 in question.

Advantageously, said assignation module communicates with said module on reception of said signal in order to initiate one of said tasks consisting at least in the management method according to the invention. In other words, on reception of the signal indicating a need for a consumable, the steps of the management method are initiated in order to transport and transfer said consumable for supplying said station 2 in question.

According to one embodiment, said reception module makes it possible to receive an end of supply notification at the end of said one of said tasks. In brief, on reception of a corresponding notification, the system 8 may know when the robot 4 has delivered the consumable, which has been unloaded, and is again available, as well as when the loading of the reception space 20 of the station 2 is ended. Thus, the mission is completed and the system 8 can reassign said robot 4 for a new task, for example the recovery of empty media 7 and their transport to a recovery zone intended for this purpose.

According to one embodiment, said supervision system 8 comprises a module for communication with the separate manager 6 of the movements of said at least one robot 4.

Furthermore, said communication module and said assignation module cooperate for planning said tasks. In other words, the supervision system 8 exchanges with the manager 6, or may integrate said manager 6, with a higher software hierarchy level in order to receive the information and take the movements of said robots 4 into consideration in the assignation of the automatic supply tasks of the stations 2 in question.

As mentioned above, according to a corresponding embodiment, said tasks comprise the transport by said at least one robot 4 of at least one transport media 7, emptied of its consumable, from one of the certain stations 2. In brief, the supervision system makes it possible to manage the removal of the medias 7 which have previously been used for the transport of the consumables.

Thus, through the interface 5 dedicated to the station 2 and to the consumable to be supplied, the management method for instructing the supply and the software system for supervising the whole, the invention offers interoperability of a plurality of means which perform automated and optimized delivery of the consumables to one or more receptacle production lines 1.

1. A consumables supply interface (5) for supplying consumables to at least one product processing station (2), comprising:
an entry (50) accessible to an autonomous mobile robot (AMR) (4) transporting a consumable corresponding to a particular product processing station (2); and
a transfer means for automatic transfer of said consumable from said robot (AMR) to a reception space for said consumable, said reception space (20) being integrated with the particular processing station (2),
wherein the transfer means comprise an automated loading means dedicated
i) to said consumable to be transferred, and
ii) to each reception space (20) of the particular processing stations (2) to be supplied with said corresponding consumable.

2. The consumables supply interface (5) as claimed in claim 1, which comprises:
an unloading zone (51) provided with said transfer means.

3. The supply interface (5) as claimed in claim 1, which comprises:
an enclosure (52) integrating said entry (50) communicating with said unloading zone (51), which is then located inside the enclosure (52),
said entry (50) being accessible by said robot (4) (AMR) upon verification.

4. The consumables supply interface (5) as claimed in claim 1, which comprises:
means for controlling the access to the entry (50) of said enclosure (52), said control means comprising means for recognition of and communication with said robot (4) (AMR).

5. The consumables supply interface (5) as claimed in claim 1, wherein said loading means comprise:
a means for taking hold of a media (7) for transport of the consumable, and
a means for extraction of the consumable from said transport media (7).

6. A line (1) for the production of products of the receptacle type, comprising:
successively along said line (1), a plurality of stations (2) for processing said products, certain of said processing stations (2) using consumables, each of said consumables corresponding to the processing of said products by one of said certain processing stations (2);
a zone (3) for storage of said consumables;
mobile means for transport of said consumables from said storage zone (3) to said certain processing stations (2);
wherein each of said certain processing stations (2) is equipped with the consumables supply interface (5) according to claim 1.

7. A method for managing a supply of consumables to certain processing stations (2) of a production line (1) as claimed in claim 7, comprising:
instructing transport of a consumable from a storage zone (3) to one of the certain processing stations (2);
transporting, using a mobile autonomous robot (AMR) (4), said consumable from the storage zone (3) to said one of the certain processing stations (2);
transferring and loading said consumable from said mobile robot (AMR) (4) to said reception space (20) of said one of the certain processing stations (2); wherein during the transfer, said robot (AMR) (4) positions itself with respect to the supply interface (5) with which said one of the certain processing stations (2) is equipped, and said consumable is automatically transferred from said robot (AMR) (4) to said reception space (20) via the loading means of said consumables supply interface (5), and said robot (AMR) (4) departs.

8. The management method as claimed in claim 7, wherein during the transfer,
said robot (4) (AMR) positions itself by entering inside an unloading zone (51) which is accessible via a secured entry (50), and
the access of said robot (4) (AMR) through said entry (50) is controlled.

9. The management method as claimed in claim 8, wherein the access of said robot (4) (AMR) through said entry (50) is controlled by recognition and communication from said interface (5).

10. The management method as claimed in claim 8, wherein the robot (4) (AMR) departs with at least one transport media (7) emptied of the consumable.

11. The management method as claimed in claim 8, wherein the transport of said consumable is instructed automatically via a signal transmitted by a sensor (21) of the level of consumption of the consumable used inside said reception space (20) of the processing station (2) in question.

12. A software system (8) for supervising the supply of consumables to processing stations of a production line (1) as claimed in claim 6,
said supervision software system (8) being run through at least one informatics terminal, comprising:
at least one software module for assigning tasks to at least one robot (4) (AMR), said tasks comprising at least the transport of consumables from said storage zone (3) to said certain processing stations (2), one of said consumables in particular corresponding to one of said certain processing stations (2) in question,
at least one module for receiving a signal instructing the supply of said corresponding consumable, said signal being transmitted by said processing station (2) in question, wherein said assignation module communicates with said module on reception of said signal in order to initiate one of said tasks.

13. The supervision software system as claimed in claim 12, wherein said reception module makes it possible to receive an end of supply notification at the end of said one of said tasks.

14. The supervision software system as claimed in claim 13, further comprising:
a module for communication with a separate manager (6) of the movements of said at least one robot (4) (AMR), said communication module and said assignation module cooperating for planning of said tasks.

15. The supervision software system as claimed in claim 12, wherein said tasks comprise the transport by said at least one robot (4) (AMR) of at least one transport media (7), emptied of its consumable, from one of the certain processing stations (2).
